(19) United States
(12) Patent Application Publication
(10) Pub. No.: US 2023/0213727 A1
(43) Pub. Date: Jul. 6, 2023

(54) OPTICAL LENS AND ASSEMBLY METHOD THEREOF

(71) Applicant: Changzhou AAC Raytech Optronics Co., Ltd., Changzhou City (CN)

(72) Inventors: Pengfei Gao, Shenzhen (CN); Haopeng Zhou, Shenzhen (CN)

(21) Appl. No.: 17/566,618

(22) Filed: Dec. 30, 2021

(51) Int. Cl. G02B 7/02; G02B 3/00

(52) U.S. Cl. CPC G02B 7/025; G02B 7/022; G02B 7/021; G02B 3/00; G02B 2003/0093

(57) ABSTRACT

The present invention provides an optical lens and an assembly method thereof The optical lens includes: a first lens barrel; a second lens barrel arranged with a first mounting portion protruding toward the first lens barrel; a first lens, comprising a first object side facing a light incident end of the optical lens, a first image side facing a light exit end of the optical lens, and a first side wall connecting the first object side and the first image side; wherein the first lens is sandwiched between the first lens barrel and the second lens barrel; the first mounting portion is arranged around the first lens and spaced from the first side wall to define a glue-holding slot; a first adhesive material, arranged between the first image side and the second lens barrel; and a second adhesive material, arranged in the glue-holding slot. In this way, the first lens can be prevented from deforming or breaking, i.e., the lateral shear strength of the optical lens can be improved.

### TECHNICAL FIELD

The present invention relates to the field of electronic technologies, and in particular to an optical lens and an assembly method thereof.

### BACKGROUND

With the popularity of mobile electronic devices, camera module related technology, which is used in mobile electronic devices to help users obtain images (such as video or images), has rapidly developed and progressed. In recent years, the camera module in areas such as medical, security, industrial production and many others have been widely used.

The camera module usually includes a circuit board, a light-sensitive chips, an electronic component and a lens barrel loaded with a lens. For the lens barrel in the existing technology, in the loading of lenses, an adhesive layer is arranged in the direction of the optical axis between the lens and the lens barrel to fix the lens. However, with this structure of the lens barrel, the stability of the lens in the direction perpendicular to the optical axis is not ensured. Especially when the lens is made of glass, because of large mass, the lens barrel in the lateral force of the glass lens is easy to shift, which affects the imaging quality of the camera module, and may even lead to glass lens collision deformation or broken.

### SUMMARY OF THE DISCLOSURE

The present invention provides an optical lens and an assembly method thereof to solve the technical problem of poor transverse shear strength of the lens of an optical lens.

To solve the above technical problems, a technical solution adopted by the present invention is to provide an optical lens, comprising: a first lens barrel; a second lens barrel, connected to the first lens barrel; wherein a surface of the second lens barrel toward the first lens barrel is arranged with a first mounting portion protruding toward the first lens barrel; a first lens, comprising a first object side facing a light incident end of the optical lens, a first image side facing a light exit end of the optical lens, and a first side wall connecting the first object side and the first image side; wherein the first lens is sandwiched between the first lens barrel and the second lens barrel; the first mounting portion is arranged around the first lens and spaced from the first side wall to define a glue-holding slot; a first adhesive material, arranged between the first image side and the second lens barrel; and a second adhesive material, arranged in the glue-holding slot.

In some embodiments, a surface of the first mounting portion toward the first lens is an inclined plane, and a distance between the first side wall and the inclined plane of the first mounting portion gradually decreases in a direction from an object side toward an image side.

In some embodiments, a first groove is defined at a position of the first lens barrel close to the first mounting portion; the first mounting portion is inserted in the first recess, and the first mounting portion abuts the first groove in a direction along an optical axis and in a direction perpendicular to the optical axis.

In some embodiments, an angle between a side of the first mounting portion back from the second adhesive material and a direction of the optical axis is 0°-10°.

In some embodiments, the optical lens further comprises a third adhesive material, the third adhesive material being arranged between the first lens barrel and the second lens barrel and arranged around a side of the first mounting portion back from an optical axis.

In some embodiments, the optical lens further comprises a second lens and a shading sheet accommodated in the second lens barrel; the second lens comprises a second object side toward the light incident end of the optical lens, a second image side toward the light exit end of the optical lens, and a second side wall connecting the second object side and the second image side; a second groove is defined on a surface of the second lens barrel toward the second object side, and the second groove comprises an opening toward the optical axis; a second mounting portion is arranged at a position of the second lens close to the second recess, and the second mounting portion is inserted in the second recess; an end of the shading sheet is sandwiched between the second groove and the second mounting portion, and the other end of the shading sheet extends in a direction close to the optical axis.

In some embodiments, the first image side of the first lens is in a wavy shape; or the first image side defines a notch at a junction with the first side wall.

To solve the above technical problems, another technical solution adopted by the present invention is to provide method of assembling an optical lens, comprising: preparing a first lens barrel, a second lens barrel, and a first lens separated from each other; wherein a surface of the second lens barrel toward the first lens barrel is arranged with a first mounting portion protruding toward the first lens barrel; the first lens comprises a first object side facing a light incident end of the optical lens, a first image side facing a light exit end of the optical lens, and a first side wall connecting the first object side and the first image side; prepositioning the first lens and the second lens barrel along an optical axis, and arranging a first adhesive material between the first image side and the second lens barrel; fixing the first lens to the second lens barrel through the first adhesive material, and arranging a second adhesive material in a glue-holding slot defined between the first side wall and the first mounting portion; arranging the first lens barrel on a side of the second lens barrel facing the first lens, and connecting the first lens barrel to the second lens barrel.

In some embodiments, the arranging the first lens barrel on a side of the second lens barrel facing the first lens, and connecting the first lens barrel to the second lens barrel comprises:

inserting the first mounting portion on the second lens barrel into a first groove on the first lens barrel, and placing the first mounting portion against the first groove in a direction along the optical axis and a direction perpendicular to the optical axis.

In some embodiments, the method further comprises: arranging a third adhesive material between the second lens barrel and the first lens barrel, wherein the third adhesive material is arranged on a side of the first mounting portion back from the optical axis.

In some embodiments, the method further comprises: preparing a second lens and a shading sheet, arranging an end of the shading sheet in a second recess, and inserting a second mounting portion on the second lens into the second groove on the second lens barrel; wherein the shading sheet is sandwiched and fixed between the second lens barrel and the second lens.

The beneficial effect of the present invention is that the present invention can bond the first lens to the second lens barrel by protruding the first mounting portion on the surface of the second lens barrel toward the first lens barrel and arranging the first adhesive material for bonding between the first image side of the first lens and the second lens barrel. The second adhesive material for bonding is arranged in the glue-holding slot between the first side wall of the first lens and the first mounting portion, which can strengthen the connection between the first lens and the second lens barrel. In addition, since the second adhesive material is arranged at the periphery of the first lens, the first lens can be prevented from shifting when the optical lens is subjected to lateral force, and the second adhesive material can cushion the force on the first lens to prevent the first lens from deforming or breaking, i.e., to improve the lateral shear strength of the optical lens.

### BRIEF DESCRIPTION OF THE DRAWINGS

In order to illustrate more clearly the technical solutions in the embodiments of the present invention, the following is a brief description of the drawings to be used in the description of the embodiments, it is obvious that the drawings in the following description are only some of the embodiments of the present invention, and that other drawings can be obtained from these drawings without creative work for those skilled in the art.

FIG. 1 is a cross-sectional structural schematic view of an optical lens according to an embodiment of the present invention.

FIG. 2 is a schematic view of a partially enlarged structure in FIG. 1.

FIG. 3 is a schematic view of a partially enlarged structure of a partial element fit in FIG. 1.

FIG. 4 is a cross-sectional structural schematic view of a first lens according to an embodiment of the present invention.

FIG. 5 is a cross-sectional structural schematic view of a first lens according to another embodiment of the present invention.

FIG. 6 is a flowchart of an assembly method of an optical lens according to an embodiment of the present invention.

### DETAILED DESCRIPTION

The technical solutions in the embodiments of the present invention will be clearly and completely described below in conjunction with the accompanying drawings in the embodiments of the present invention, and it is clear that the described embodiments are only a part of the embodiments of the present invention, but not all of them. Based on the embodiments in the present invention, all other embodiments obtained by those skilled in the art without making creative labor fall within the scope of the present invention.

It should be noted that in this specification, expressions “first”, “second”, “third”, etc. are intended only to distinguish one feature from another and do not indicate any limitation of the features. Therefore, without departing from the teachings of the present invention, the first lens barrel discussed below may also be referred to as a second lens barrel.

In the accompanying drawings, the thickness, size and shape of the components may have been slightly exaggerated for ease of illustration. Specifically, the shape of the spherical or aspheric surfaces shown in the accompanying drawings is illustrated by way of example. That is, the shape of the spherical or aspheric surfaces is not limited to the shape of the spherical or aspheric surfaces illustrated in the accompanying drawings. The accompanying drawings are examples only and are not drawn strictly to scale.

It is also to be understood that the terms “include”, “comprise”, “have”, “contain,” and/or “embody”, when used in this specification, denote the presence of the stated features, components and/or parts, but do not exclude the presence or addition of one or more other features, components, parts, and/or combinations thereof. In addition, when expressions such as “at least one of” appearing before a list of listed features, the entire listed features are modified, rather than any individual component in the list. In addition, when describing an embodiment of the present invention, terms “may” are intended to indicate “one or more embodiments of the present invention”. Also, terms “exemplary” are intended to refer to examples or illustrative examples.

It should be noted that the embodiments and features of the embodiments in the present invention may be combined with each other without conflict. Further, unless expressly limited or contradicted by the context, the specific steps contained in the methods documented in the present invention are not necessarily limited to the order documented, but may be performed in any order or in parallel. The present invention will be described in detail below with reference to the accompanying drawings and in conjunction with embodiments.

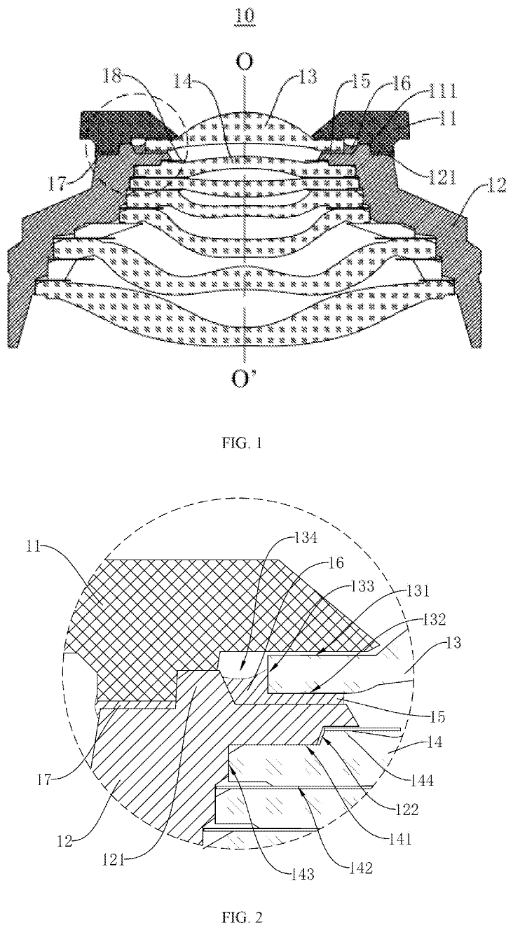

The present invention provides an optical lens 10, as shown in FIG. 1 and FIG. 2. FIG. 1 is a cross-sectional structural schematic view of an optical lens 10 according to an embodiment of the present invention. FIG. 2 is a schematic view of a partially enlarged structure in FIG. 1. The optical lens 10 includes a first lens barrel 11, a second lens barrel 12, a first lens 13, a first adhesive material 15, and a second adhesive material 16. The second lens barrel 12 is connected to the first lens barrel 11, and a surface of the second lens barrel 12 toward the first lens barrel 11 is arranged with a first mounting portion 121 protruding toward the first lens barrel 11. The first lens 13 includes a first object side 131 facing a light incident end of the optical lens 10, a first image side 132 facing a light exit end of the optical lens 10, and a first side wall 133 connecting the first object side 131 and the first image side 132. The first lens 13 is sandwiched between the first lens barrel 11 and the second lens barrel 12. The first mounting portion 121 is arranged around the first lens 13 and spaced from the first side wall 133 for froming a glue-holding slot 134. The first adhesive material 15 is arranged between the first image side 132 and the second lens barrel 12. The second adhesive material 16 is arranged in the glue-holding slot 134.

In summary, in the present invention, the first mounting portion 121 is protruding from the surface of the second lens barrel 12 toward the first lens barrel 11, and the first adhesive material 15 for bonding is arranged between the first image side 132 of the first lens 13 and the second lens barrel 12, thereby bonding the first lens 13 to the second lens barrel 12 for fixing. The second adhesive material 16 for bonding is arranged in the glue-holding slot 134 between the first side wall 133 of the first lens 13 and the first mounting portion 121, thereby strengthening the connection strength of the first lens 13 and the second lens barrel 12. Since the second adhesive material 16 is arranged at a periphery of the first lens 13, the first lens 13 may be prevented from shifting when the optical lens 10 is subjected to a lateral force. In addition, the second adhesive material 16 may cushion the force on the first lens 13 to prevent deformation or breaking of the first lens 13, i.e., to improve the lateral shear strength of the optical lens 10.

The first image side 132 of the first lens 13 refers specifically to a surface of the first lens 13 along the optical axis toward the image side, and the first object side 131 of the first lens 13 refers specifically to a surface of the first lens 13 along the optical axis toward the object side.

In some embodiments, the first adhesive material 15 may be arranged separately from the second adhesive material 16, or the first adhesive material 15 may be arranged as a one-piece structure with the second adhesive material 16.

Further, as shown in FIG. 1, a surface of the first mounting portion 121 toward the first lens 13 may be arranged to be an inclined plane, the inclined plane being inclined in a direction from the object side toward the image side, and the distance between the first side wall 133 of the first lens 13 and the inclined plane of the first mounting portion 121 gradually decreasing.

Specifically, the first mounting portion 121 and the first side wall 133 of the first lens 13 are relatively spaced apart for forming the glue-holding slot 134 for holding the second adhesive material 16 between the first mounting portion 121 and the first lens 13. By arranging the surface of the first mounting portion 121 to be the inclined plane and by arranging the distance between the inclined plane of the first mounting portion 121 and the first side wall 133 of the first lens 13 decreasing in a downward direction shown in the figure, the slot may have a larger opening for the filling of the second adhesive material 16, and the curing of the second adhesive material 16 may be facilitated.

Further, as shown in FIG. 1, a surface of the first lens barrel 11 toward the first lens 13 may be spaced apart from the first lens 13 for reducing a contact area between the first lens 13 and the first lens barrel 11 for preventing damage to the first lens 13 from the first lens barrel 11.

Further, as shown in FIG. 1, a first groove 111 is defined at a position of the first lens barrel 11 close to the first mounting portion 121. The first mounting portion 121 is inserted in the first groove 111, and the first mounting portion 121 abuts the first groove 11 in a direction along the optical axis OO′ as well as in a direction perpendicular to the optical axis OO′, thereby achieving positioning of the first lens barrel 11 and the second lens barrel 12 in the two directions.

Specifically, a top surface of the first mounting portion 121 abuts against a bottom surface of the first groove 111, and a side of the first mounting portion 121 back from the second adhesive material 16 abuts against a side of the first groove 111 to achieve the positioning of the first lens barrel 11 and the second lens barrel 12 in the vertical direction and in the radial direction along the optical lens.

Further, the first groove 111 has an opening in the direction of the optical axis OO′, the first mounting portion 121 is accommodated in the first groove 111, and the top surface of the first mounting portion 121 abuts against the bottom surface of the first groove 111. The surface of the first mounting portion 121 facing the optical axis OO′ is arranged with the second adhesive material 16, and the surface of the first mounting portion 121 back from the optical axis OO′ abuts against the side of the first groove 111. The top surface of the first mounting portion 121 abuts against the bottom surface of the first groove 111 to position and limit the first lens barrel 11 in the direction of the optical axis OO′. The side of the first mounting portion 121 back from the second adhesive material 16 abuts against the side of the first recess 111, such that the first lens barrel 11 may be positionally limited along the direction perpendicular to the optical axis OO′ by the side fit. In this way, through the fitting structure of the first mounting portion 121 and the first groove 111, the positioning of the first lens barrel 11 along the optical axis OO′ direction and perpendicular to the optical axis OO′ direction may be achieved, and the first lens barrel 11 may be prepositioned before fixing the first lens barrel 11 and the second lens barrel 12, and thereby achieving the precise control of the first lens barrel 11 in the relative position of the entire optical lens 10, facilitating the connection of the first lens barrel 11 and the second lens barrel 12.

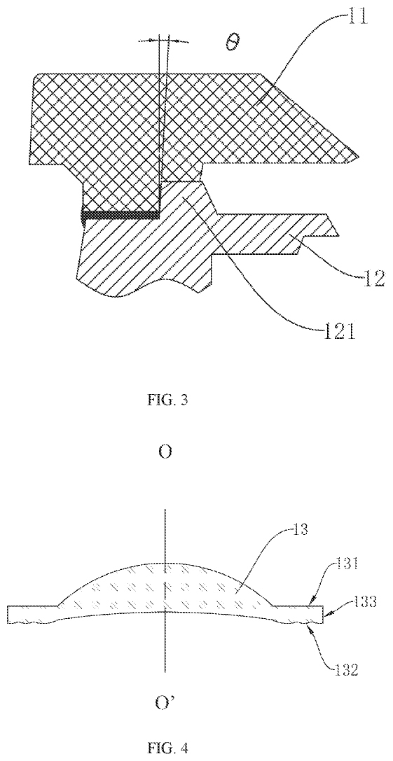

Further, as shown in FIG. 3, FIG. 3 is a schematic view of a partially enlarged structure of a partial element fit in FIG. 1. An angle 0 between the side of the first mounting portion 121 back from the second adhesive material 16 and the direction of the optical axis OO′ may be set to be 0°-10°. For example, the angle θ between the side of the first mounting portion 121 back from the second adhesive material 16 and the direction of the optical axis OO′ may be 0°, 1°, 2°, 3°, 4°, 5°, 6°, 7°, 8°, 9°, or 10°. By forming a wedge-shaped angle on the side of the first mounting portion 121, the second lens barrel 12 may be easily molded out and the fabrication tolerances of the first lens barrel 11 and the second lens barrel 12, which can affect the installation, may be avoided.

In some embodiments, the height of the first mounting portion 121 protruding from the surface of the second lens barrel 12 may be adjusted according to the length of the side fit, without specific limitation in the present invention.

Further, as shown in FIG. 1, the optical lens 10 includes a third adhesive material 17, which is arranged between the first lens barrel 11 and the second lens barrel 12 and around a side of the first mounting portion 121 back from the optical axis OO′ for holding the first lens barrel 11 and the second lens barrel 12 in place.

In some embodiments, the third adhesive material 17 may be of the same material as the first adhesive material 15 and the second adhesive material 16, or the third adhesive material 17 may be of a different material from the first adhesive material 15 and the second adhesive material 16.

Further, as shown in FIGS. 1 and 2, the optical lens 10 further includes a second lens 14, the second lens 14 being accommodated within the second lens barrel 12. The second lens 14 includes a second object side 141 toward the light incident end of the optical lens 10, a second image side 142 toward the light exit end of the optical lens 10, and a second side wall 143 connecting the second object side 141 and the second image side 142.

To ensure sufficient space between the first lens 13 and the second lens 14, a second groove 122 may be defined on a surface of the second lens barrel 12 toward the second object side 141 of the second lens 14, and a second mounting portion 144 is arranged at a position of the second lens 14 close to the second groove 122. The second mounting portion 144 is inserted in the second groove 122.

In the embodiments, as shown in FIG. 1, the second groove 122 has an opening toward the optical axis OO′ side. The optical lens 10 further includes a shading sheet 18, an end of which is sandwiched between the second groove 122 and the second mounting portion 144, and the other end of which extends in the direction close to the optical axis OO′. In this way, a part of the shading sheet 18 located in the second groove 122 may be fixed by a cantilever structure formed by the second mounting portion 144 and the second groove 122 to ensure that there is enough space to add the shading sheet 18, and a part of the shading sheet 18 extending out of the second groove 122 may be configured to shade light to avoid the problem that the light passage hole is prone to fusing by using the second lens barrel 12 to shade light, thereby improving the shading effect of the optical lens 10 and preventing stray light.

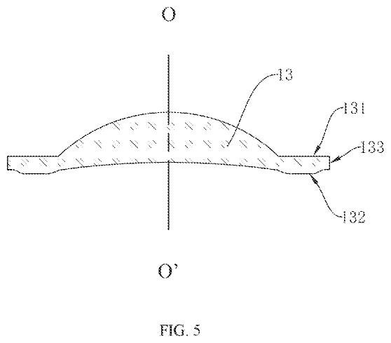

Further, as shown in FIG. 4, in order to enhance the connection strength of the first lens 13 and the first lens barrel 11, the first image side 132 of the first lens 13 may be set in a wavy shape, such that the contact area between the first image side 132 of the first lens 13 and the first adhesive material 15 may be increased, thereby enhancing the bonding strength of the first adhesive material 15 to the first lens 13. In this way, the first adhesive material 15 may generate a force with the first lens 13 in the direction perpendicular to the optical axis, which in turn enhances the lateral shear strength of the first lens 13 to the second lens barrel 12.

According to other embodiments of the present invention, a notch may be defined at a junction of the first image side 132 and the first side wall 133 of the first lens 13 as shown in FIG. 5. In this way, the notch is defined to further increase the space for setting the second adhesive material 16, which in turn enhances the bonding ability of the second adhesive material 16 and enhances the lateral shear strength of the first lens 13 and the second lens barrel 12.

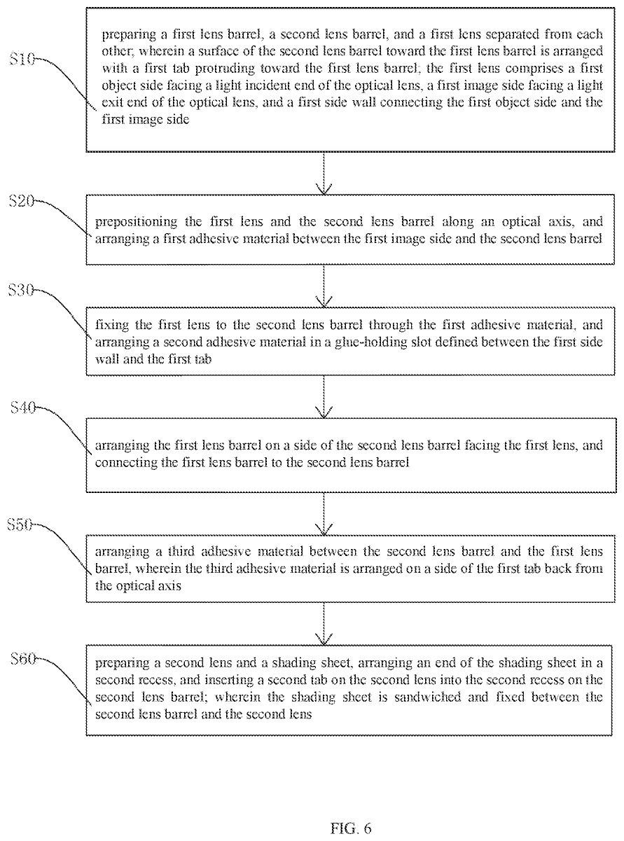

Based on the optical lens 10 in the above embodiments, the present invention also provides a method of assembling the optical lens 10. As shown in FIG. 6, FIG. 6 is a flowchart of an assembly method of an optical lens 10 according to an embodiment of the present invention. The method of assembling the optical lens 10 includes the following operations at blocks.

In step S10: preparing a first lens barrel 11, a second lens barrel 12, and a first lens 13 separated from each other; wherein a surface of the second lens barrel 12 toward the first lens barrel 11 is arranged with a first mounting portion 121 protruding toward the first lens barrel 11; the first lens 13 includes a first object side 131 facing a light incident end of the optical lens 10, a first image side 132 facing a light exit end of the optical lens 10, and a first side wall 133 connecting the first object side 131 and the first image side 132.

Further referring to FIG. 1, the optical lens 10 includes the first lens barrel 11 and the second lens barrel 12. In the preparation of the optical lens 10, at least one lens may be arranged for each of the first lens barrel 11 and the second lens barrel 12. The function of the lens barrel is to fix the corresponding lens(es) and to maintain the relative position of the multiple lenses within the lens barrel. As shown in FIG. 1, one first lens 13 is arranged for the first barrel 11 and six second lenses 14 are arranged for the second barrel 12. However, it is readily understood by those skilled in the art that the number of lenses contained in each barrel may be determined according to actual needs without limitation. For example, the first lens barrel 11 may be arranged with two, three or four lenses, while the second lens barrel 12 may be arranged with one, two, three or four lenses.

Among them, the first lens barrel 11 and the second lens barrel 12 are connected along the optical axis OO′ direction of the optical lens 10. Compared with the conventional optical lens 10 that assembles multiple lenses in the same barrel, the present invention can adjust the relative position between the lenses and thus adjust the imaging quality of the camera module.

In step S20: prepositioning the first lens 13 and the second lens barrel 12 along an optical axis OO′, and arranging a first adhesive material 15 between the first image side 132 and the second lens barrel 12.

Specifically, a relative displacement of a capturing mechanism with respect to the fixing mechanism may be controlled to preposition the first lens 13 and the second lens barrel 12. For example, in the embodiment illustrated in FIG. 1, the second lens barrel 12 may be clamped and fixed with the fixing mechanism (not shown) and the first lens 13 may be clamped with the capturing mechanism (not shown). The capturing mechanism is controlled to drive the first lens 13 closer to the second lens barrel 12. During the proximity, it should generally be ensured that the first lens 13 and the second lens barrel 12 do not touch each other, such that a gap may be defined between the first image side 132 of the first lens 13 and the second lens barrel 12. In the embodiments, the gap may be understood to be between structural surfaces of the first lens 13 and the second lens barrel 12 that can accommodate glue. The structural surface of the first lens 13 may be the first image side 132 of the first lens 13, and the structural surface of the second lens barrel 12 may be the top surface of the second lens barrel 12.

The first adhesive material 15 may be a light curable adhesive. For example, the first adhesive material 15 may be ultraviolet (UV) curable adhesive. A photoinitiator (or photosensitizer) in the UV curable adhesive generates reactive radicals or cations after UV irradiation and UV absorption, triggering monomer polymerization and cross-linking chemical reactions, such that the first adhesive material 15 can be converted from liquid to solid in a short time.

In some embodiments, the first adhesive material 15 may be a photo-thermally curable adhesive. The photo-thermally curable adhesive may be cured under conditions of light irradiation of a corresponding spectrum and heating. For example, the first adhesive material 15 may be a UV-thermally curable adhesive.

After applying the first adhesive material 15 to fill between the first lens 13 and the second barrel 12, a step S30 may be performed: fixing the first lens 13 to the second lens barrel 12 through the first adhesive material 15, and arranging a second adhesive material 16 in a glue-holding slot 134 defined between the first side wall 133 and the first mounting portion 121.

Specifically, the cross-sectional shape of the first lens 13 is substantially the same as the shape of the area enclosed by the first mounting portion 121, and the first side wall 133 of the first lens 13 is spaced from the side of the first mounting portion 121 for forming a gap between the first side wall 133 of the first lens 13 and the side of the first mounting portion 121, which may be used to arrange the second adhesive material 16 to connect the first lens 13 and the second lens barrel 12, thereby enhancing the connection strength of the first lens 13 and the second lens barrel 12. Since the second adhesive material 16 is arranged at the periphery of the first lens 13, it can cushion the force on the first lens 13 when the optical lens 10 is subjected to a lateral force, thereby avoiding the first lens 13 from being deformed or broken, i.e., improving the lateral shear strength of the optical lens 10.

In some embodiments, the second adhesive material 16 may be a thermally curable adhesive, for example, an epoxy resin, etc. The thermally curable adhesive may undergo curing under heated conditions.

In some embodiments, the second adhesive material 16 may also be a photo-thermally curable adhesive.

Although light curable adhesive, thermally curable adhesive and photo-thermally curable adhesive are shown in this disclosure as examples of the first adhesive material 15 and the second adhesive material 16, it should be understood by those skilled in the art that the types of the first adhesive material 15 and the second adhesive material 16 are not limited thereto. Any type of adhesive may be used depending on actual needs. For example, a catalyst curable adhesive may also be used. The first adhesive material 15 and the second adhesive material 16 are arranged in such a way and with such materials that the first adhesive material 15 and second adhesive material 16 are cured successively at different times. For example, when both the first adhesive material 15 and the second adhesive material 16 are photo-thermally curable adhesives, adhesives having different curing temperatures may be selected. Alternatively, a light opening between the first side wall 133 of the first lens 13 and the surface of the second lens barrel 12 is set independent in terms of receiving light with a light opening between the first side wall 133 of the first lens 13 and the side of the first mounting portion 121.

After setting the second adhesive material 16 between the first lens 13 and the first mounting portion 121, a step S40 may be performed: arranging the first lens barrel 11 on a side of the second lens barrel 12 facing the first lens 13 and connecting the first lens barrel 11 to the second lens barrel 12.

Specifically, the size of the area surrounded by the first lens barrel 11 is smaller than the size of the first lens 13, and after the first lens barrel 11 and the second lens barrel 12 are connected, the first lens barrel 11 will remain on the side of the first lens 13 back from the second lens barrel 12 to protect the first lens 13 from being damaged or broken by contacting the first lens 13 with a foreign object.

The surface of the first lens barrel 11 toward the first lens 13 may be spaced from the surface of the first lens 13. Alternatively, the surface of the first lens barrel 11 toward the first lens 13 may be in contact with each other and the surface of the first lens 13.

In a specific embodiment, the step of arranging the first lens barrel 11 on the side of the second lens barrel 12 facing the first lens 13 and connecting the first lens barrel 11 to the second lens barrel 12 include: inserting the first mounting portion 121 on the second lens barrel 12 into the first groove 111 on the first lens barrel 11, and placing the first mounting portion 121 against the first groove 111 in both the direction along the optical axis OO′ and the direction perpendicular to the optical axis OO′, thereby achieving the positioning of the first lens barrel 11 and the second lens barrel 12 in these two directions.

Specifically, the first mounting portion 121 is arranged on the surface of the second lens barrel 12 toward the first lens barrel 11, and the first groove 111 is defined on the surface of the first lens barrel 11 toward the second lens barrel 12, such that the first mounting portion 121 is just inserted in the first groove 111 when the second lens barrel 12 and the first lens barrel 11 are mated in alignment. In this way, the top surface of the first mounting portion 121 and the bottom surface of the first groove 111 may position and limit the first lens barrel 11 along the axial direction of the optical lens 10. The side of the first mounting portion 121 back from the second adhesive material 16 abutting against the side of the first groove 111 can ensure the radial limit of the first lens barrel 11 by the side fit. In this way, through the fitting structure of the first mounting portion 121 and the first groove 111, the positioning of the first lens barrel 11 along the optical axis OO′ direction and perpendicular to the optical axis OO′ direction may be achieved, and the first lens barrel 11 may be prepositioned before fixing the first lens barrel 11 and the second lens barrel 12, and thereby achieving the precise control of the first lens barrel 11 in the relative position of the entire optical lens 10, facilitating the connection of the first lens barrel 11 and the second lens barrel 12.

Referring to FIG. 5, after performing the step S40 to connect the first lens barrel 11 and the second lens barrel 12, a step S50 is performed: arranging a third adhesive material 17 between the second lens barrel 12 and the first lens barrel 11, wherein the third adhesive material 17 is arranged on the side of the first mounting portion 121 back from the optical axis OO′.

Specifically, the third adhesive material 17 for fixing the first lens barrel 11 and the second lens barrel 12 is arranged on the outside of the first mounting portion 121, and the third adhesive material 17 is used to fix the first lens barrel 11 and the second lens barrel 12 to avoid the problem of stray light due to group bias.

In some embodiments, the third adhesive material 17 may be a thermally curable adhesive, for example, an epoxy resin, etc. The thermally curable adhesive may undergo curing under heated conditions. The third adhesive 17 may also be a photo-thermally curing adhesive. The third adhesive 17 may also be a light curable adhesive, for example.

Further, referring to FIG. 6, after bonding the first lens barrel 11 and the second lens barrel 12 by the third adhesive material 17, a step S60 is performed: preparing a second lens 14 and a shading sheet 18, arranging an end of the shading sheet 18 in a second groove 122, and inserting a second mounting portion 144 on the second lens 14 into the second groove 122 on the second lens barrel 12, wherein the shading sheet 18 is sandwiched and fixed between the second lens barrel 12 and the second lens 14.

Specifically, as shown in FIG. 1, the second groove 122 is defined on the surface of the second lens barrel 12 toward the second lens 14, and the second mounting portion 144 is arranged on the surface of the second lens 14 toward the second barrel 12. The second mounting portion 144 is inserted into the second groove 122 when the second barrel 12 and the second lens 14 are mated in alignment.

The second groove 122 has an opening toward the optical axis OO′ side, such that a part of the shading sheet 18 located in the second groove 122 may be fixed by a cantilever structure formed by the second mounting portion 144 and the second groove 122 to ensure that there is enough space to add the shading sheet 18, and a part of the shading sheet 18 extending out of the second groove 122 may be configured to shade light to avoid the problem that the light passage hole is prone to fusing by using the second lens barrel 12 to shade light, thereby improving the shading effect of the optical lens 10 and preventing stray light.

The above is only embodiments of the present invention, but not to limit the scope of the present invention. Any equivalent structure or equivalent process transformation made by using the contents and the attached drawings of the present invention, or directly or indirectly applied in other related technical fields, are included in the scope of the present invention.

What is claimed is:

1. An optical lens, comprising:
a first lens barrel;
a second lens barrel, connected to the first lens barrel; wherein a surface of the second lens barrel toward the first lens barrel is arranged with a first mounting portion protruding toward the first lens barrel;
a first lens, comprising a first object side facing a light incident end of the optical lens, a first image side facing a light exit end of the optical lens, and a first side wall connecting the first object side and the first image side; wherein the first lens is sandwiched between the first lens barrel and the second lens barrel; the first mounting portion is arranged around the first lens and spaced from the first side wall for forming a glue-holding slot;
a first adhesive material, arranged between the first image side and the second lens barrel; and
a second adhesive material, arranged in the glue-holding slot.

2. The optical lens according to claim 1, wherein a surface of the first mounting portion toward the first lens is an inclined plane, and a distance between the first side wall and the inclined plane of the first mounting portion gradually decreases in a direction from an object side toward an image side.

3. The optical lens according to claim 1, wherein a first groove is defined at a position of the first lens barrel close to the first mounting portion; the first mounting portion is inserted in the first recess, and the first mounting portion abuts the first groove in a direction along an optical axis and in a direction perpendicular to the optical axis.

4. The optical lens according to claim 3, wherein an angle between a side of the first mounting portion back from the second adhesive material and a direction of the optical axis is 0°-10°.

5. The optical lens according to claim 1, further comprising a third adhesive material, the third adhesive material being arranged between the first lens barrel and the second lens barrel and arranged around a side of the first mounting portion back from an optical axis.

6. The optical lens according to claim 5, further comprising a second lens and a shading sheet accommodated in the second lens barrel; the second lens comprises a second object side toward the light incident end of the optical lens, a second image side toward the light exit end of the optical lens, and a second side wall connecting the second object side and the second image side; a second groove is formed on a surface of the second lens barrel toward the second object side, and the second groove comprises an opening toward the optical axis; a second mounting portion is arranged at a position of the second lens close to the second recess, and the second mounting portion is inserted in the second recess; an end of the shading sheet is sandwiched between the second groove and the second mounting portion, and the other end of the shading sheet extends in a direction close to the optical axis.

7. The optical lens according to claim 1, wherein the first image side of the first lens is in a wavy shape.

8. The optical lens according to claim 1, wherein the first image side defines a notch at a junction with the first side wall.

9. A method of assembling an optical lens, comprising:
preparing a first lens barrel, a second lens barrel, and a first lens separated from each other; wherein a surface of the second lens barrel toward the first lens barrel is arranged with a first mounting portion protruding toward the first lens barrel; the first lens comprises a first object side facing a light incident end of the optical lens, a first image side facing a light exit end of the optical lens, and a first side wall connecting the first object side and the first image side;
prepositioning the first lens and the second lens barrel along an optical axis, and arranging a first adhesive material between the first image side and the second lens barrel;
fixing the first lens to the second lens barrel through the first adhesive material, and arranging a second adhesive material in a glue-holding slot defined between the first side wall and the first mounting portion; and
arranging the first lens barrel on a side of the second lens barrel facing the first lens, and connecting the first lens barrel to the second lens barrel.

10. The method according to claim 9, wherein the arranging the first lens barrel on a side of the second lens barrel facing the first lens, and connecting the first lens barrel to the second lens barrel comprises:
inserting the first mounting portion on the second lens barrel into a first groove on the first lens barrel, and placing the first mounting portion against the first groove in a direction along the optical axis and a direction perpendicular to the optical axis.

11. The method according to claim 10, further comprising:
arranging a third adhesive material between the second lens barrel and the first lens barrel, wherein the third adhesive material is arranged on a side of the first mounting portion back from the optical axis.

12. The method according to claim 9, further comprising:
preparing a second lens and a shading sheet, arranging an end of the shading sheet in a second recess, and inserting a second mounting portion on the second lens into the second groove on the second lens barrel; wherein the shading sheet is sandwiched and fixed between the second lens barrel and the second lens.
